(19) United States
(12) Patent Application Publication
(10) Pub. No.: US 2010/0156086 A1
(43) Pub. Date: Jun. 24, 2010

(54) INFORMATION PROVIDING APPARATUS, RECORDING MEDIUM AND INFORMATION PROVIDING METHOD

(75) Inventors: Yuki YAI, Kawasaki (JP); Tetsuya MIZUKAMI, Kawasaki (JP); Kensuke OKANO, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/636,265

(22) Filed: Dec. 11, 2009

(30) Foreign Application Priority Data
Dec. 24, 2008 (JP) 2008-327559

(51) Int. Cl. B42D 15/00

(52) U.S. Cl. 283/32; 283/56; 283/117

(57) ABSTRACT

An information providing apparatus includes a leaflet obtaining section, a leaflet analysis section that extracts information on the leaflet obtained by the leaflet obtaining section and updates leaflet list data, the leaflet list data being a list of the information extracted from a plurality of the leaflets, a preference analysis section that calculates the number of appearances of information of the same keyword in the leaflet list data and generates preference data in which a correspondence between the keyword and the number of appearances thereof has been recorded, a recommendation information generation section that selects a keyword based on the number of appearances in the preference data, extracts information including the selected keyword from the leaflet list data, and generates recommendation information based on the extracted information, and a recommendation information providing section that provides the recommendation information to a user.

### CROSS-REFERENCE TO RELATED APPLICATIONS

This application is based upon and claims the benefit of priority from the prior Japanese Patent Application No. 2008-327559 filed on Dec. 24, 2008, the entire contents of which are incorporated herein by reference.

### FIELD

An embodiment to be herein described relates to an information providing apparatus that provides information with which a “leaflet” conforming to preferences of a user can be efficiently found, a recording medium recording an information providing program for causing a computer to operate as such an information providing apparatus, and an information providing method.

### BACKGROUND

In modern society, there is a vast amount of obtainable information, and users see how efficiently information needed by the users can be found, as a problem.

For example, conventionally, the user has been able to search for a favorite store from history information on references made by the user in the past on a leaflet site, and refer to a leaflet of the store. However, for information on a leaflet advertising a short-term sale such as a special sale or a one-time sale, the user had to take a lot of trouble and time to find such information from a vast number of leaflets.

For example, Japanese Patent Laid-Open No. 2003-242406 has proposed a system in which information on a place to get on and a place to get off is received from a terminal of a user using trains or buses, and advertising information selected based on the received information is provided to the user's terminal.

However, in this system, although information based on the user's action area such as the place to get on or the place to get off is provided, information suitable for preferences of the user is not provided.

Moreover, for example, Japanese Patent Laid-Open No. 2000-207412 has proposed a system in which a user is caused to designate an area and also to input searched information other than the area, and information matching the searched information in the designated area is provided to the user.

However, this system also only limits the area, and is not different at all from common search systems in other points.

### SUMMARY

An information providing apparatus includes a leaflet obtaining section, a leaflet analysis section that extracts information on the leaflet obtained by the leaflet obtaining section and updates leaflet list data, the leaflet list data being a list of the information extracted from a plurality of the leaflets, a preference analysis section that calculates the number of appearances of information of the same keyword in the leaflet list data and generates preference data in which a correspondence between the keyword and the number of appearances thereof has been recorded, a recommendation information generation section that selects a keyword based on the number of appearances in the preference data, extracts information including the selected keyword from the leaflet list data, and generates recommendation information based on the extracted information, and a recommendation information providing section that provides the recommendation information to a user.

The object and advantages of the various embodiments will be realized and attained by means of the elements and combinations particularly pointed out in the claims. It is to be understood that both the foregoing general description and the following detailed description are exemplary and explanatory and are not restrictive of the various embodiments, as claimed.

Additional aspects and/or advantages will be set forth in part in the description which follows and, in part, will be apparent from the description, or may be learned by practice of the various embodiments.

### BRIEF DESCRIPTION OF THE DRAWINGS

FIG. 1 depicts a network system;

FIG. 2 depicts a configuration of an information providing program;

FIG. 3 is a functional block diagram of an information providing apparatus;

FIG. 4 is a flowchart illustrating a series of processes performed within a PC;

FIG. 5 depicts an example of a leaflet;

FIG. 6 depicts an example of leaflet list data;

FIG. 7 depicts an example of preference data;

FIG. 8 depicts an example of recommendation level data; and

FIG. 9 depicts an example of recommendation information.

### DETAILED DESCRIPTION OF THE EMBODIMENT(S)

Hereinafter, an embodiment of the present application will be described.

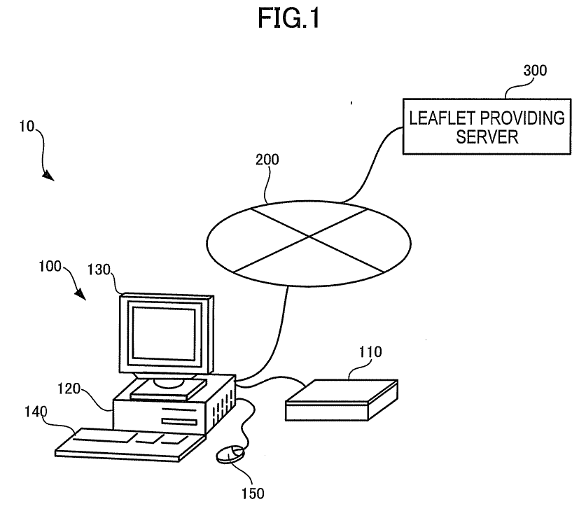

FIG. 1 illustrates a network system. A network system 10 in FIG. 1 includes the Internet 200, a personal computer (hereinafter, abbreviated as “PC”) 100 which is connected to the Internet 200 and constitutes an embodiment of the present application, and a leaflet providing server 300 connected to the Internet 200.

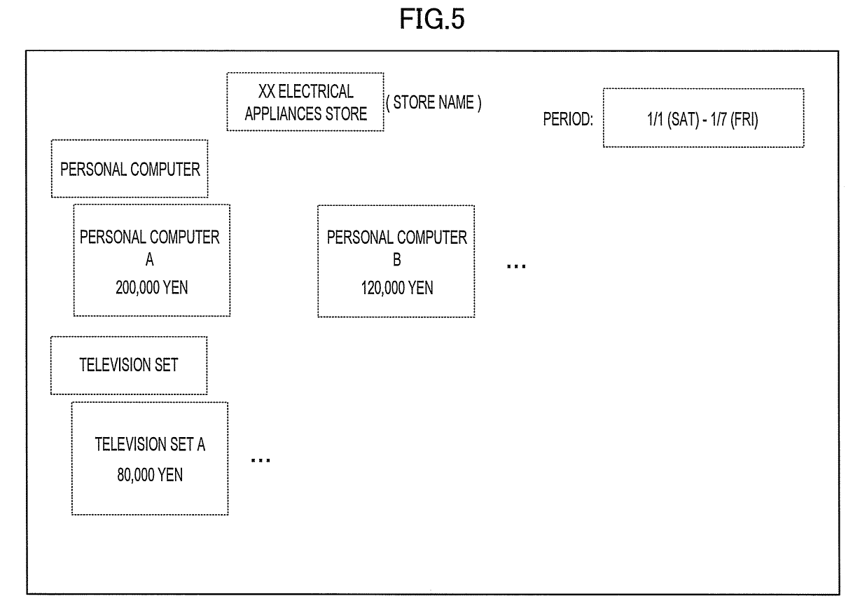

The leaflet providing server 300 is a server which provides data representing a leaflet image (hereinafter, simply referred to as “leaflet”) to various users (here, represented by the PC 100) via the Internet 200. The “leaflet” described here is, for example, an advertisement in which a store name (XX electrical appliances), commodity names (personal computer A, personal computer B, television set A . . . ) for each genre (personal computer, television set . . . ), prices (200 thousand yen, 120 thousand yen, 80 thousand yen . . . ), a sale period (1/1 (Sat)-1/7 (Fri)) and the like have been inserted, as illustrated in FIG. 5.

Moreover, the PC 100 is provided with a scanner 110 which scans a printed material as image data. The PC 100 can also scan the leaflet as the printed material, for example, such as a folded leaflet in newspapers, and obtain the leaflet by using the scanner 110.

This PC 100 is a general-purpose computer, and includes a CPU, a memory, an HDD (hard disk drive) and the like. Moreover, the PC 100 is provided with a main body apparatus 120 which performs various processes by executing programs, an image display apparatus 130 which displays images, a keyboard 140, a mouse 150 and the like.

Since the PC 100 does not need any special hardware configuration, a more detailed description thereof is omitted here.

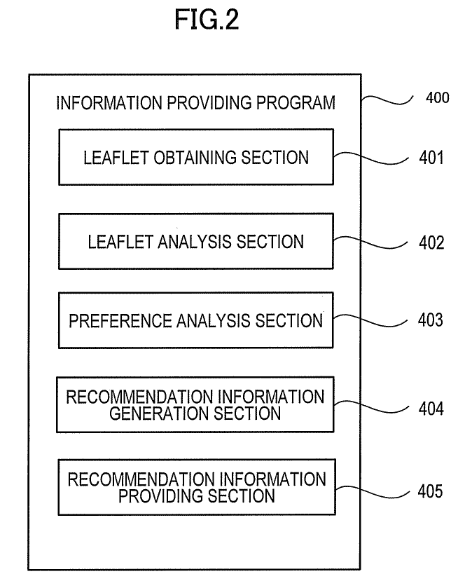

FIG. 2 is a diagram illustrating a configuration of an information providing program executed within the PC 100.

This information providing program 400 includes respective program parts constituting a leaflet obtaining section 401, a leaflet analysis section 402, a preference analysis section 403, a recommendation information generation section 404, and a recommendation information providing section 405. Operations of the respective program parts will be described later.

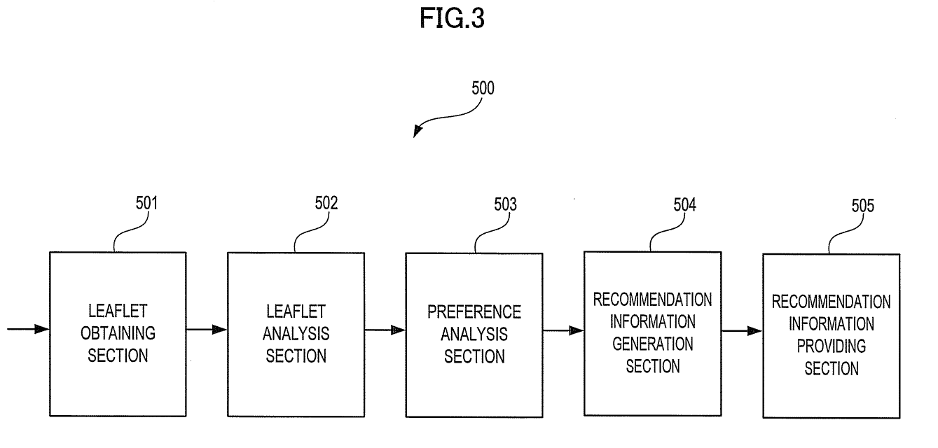

FIG. 3 is a functional block diagram of an information providing apparatus 500 constructed within the PC 100 by the information providing program 400 illustrated in FIG. 2 when the program 400 has been executed within the PC 100.

This information providing apparatus 500 includes a leaflet obtaining section 501, a leaflet analysis section 502, a preference analysis section 503, a recommendation information generation section 504, and a recommendation information providing section 505.

Here, the leaflet obtaining section 501, the leaflet analysis section 502, the preference analysis section 503, the recommendation information generation section 504, and the recommendation information providing section 505 in this information providing apparatus 500 are elements corresponding to the leaflet obtaining section 401, the leaflet analysis section 402, the preference analysis section 403, the recommendation information generation section 404, and the recommendation information providing section 405 in the information providing program 400, respectively. Moreover, the leaflet obtaining section 501, the leaflet analysis section 502, the preference analysis section 503, the recommendation information generation section 504, and the recommendation information providing section 505, which constitute the information providing apparatus 500 illustrated in FIG. 3, are also composites of hardware of the PC 100 and the respective program parts of the information providing program 400 executed within the PC 100 (the leaflet obtaining section 401, the leaflet analysis section 402, the preference analysis section 403, the recommendation information generation section 404, and the recommendation information providing section 405). Moreover, the leaflet obtaining section 401, the leaflet analysis section 402, the preference analysis section 403, the recommendation information generation section 404, and the recommendation information providing section 405, which constitute the information providing program 400, are the program parts which realize respective functions of the information providing apparatus 500 illustrated in FIG. 3 (the leaflet obtaining section 501, the leaflet analysis section 502, the preference analysis section 503, the recommendation information generation section 504, and the recommendation information providing section 505) by being executed within the PC 100.

Hereinafter, respective functional elements of the information providing apparatus 500 illustrated in FIG. 3 will be described. The following description also corresponds to descriptions of the respective operations when the respective program parts of the information providing program 400 illustrated in FIG. 2 have been executed within the PC 100.

The leaflet obtaining section 501 constituting the information providing apparatus 500 illustrated in FIG. 3 is in charge of obtaining the leaflet as the image data. In the present embodiment, this leaflet obtaining section 501 obtains the leaflet as the image data through the Internet 200. Moreover, this leaflet obtaining section 501 can obtain the leaflet as the image data by reading the leaflet as the printed material by the scanner 110.

Moreover, the leaflet analysis section 502 plays a role of analyzing the leaflet obtained by the leaflet obtaining section 501, extracting information which has appeared on the leaflet, and updating leaflet list data which is a list of a plurality of pieces of the extracted information. Details of the leaflet list data will be described later. Since the leaflet which is an analysis target is the leaflet on the image data in the present embodiment, this leaflet analysis section 502 extracts the information which has appeared on the leaflet as the image data, by character recognition.

This leaflet analysis section 502 extracts at least the commodity name, the price, a sale deadline or period, and the store name from the leaflet.

Moreover, the preference analysis section 503 calculates the number of appearances of the same keyword in the leaflet list data, and generates preference data in which a correspondence between the keyword and the number of appearances thereof has been recorded. Details of the preference data will be described later.

Furthermore, the recommendation information generation section 504 selects a keyword based on the number of appearances in the preference data, extracts information including the selected keyword from the leaflet list data, and generates recommendation information. This recommendation information generation section 504 calculates a recommendation level for each keyword by using the number of appearances in the preference data as at least one basis, and selects a keyword in which the user is interested, based on the recommendation level.

Furthermore, the recommendation information providing section 505 provides the recommendation information to the user. In the present embodiment, this providing is performed by displaying the recommendation information on a display screen of the image display apparatus 130 in the PC 100.

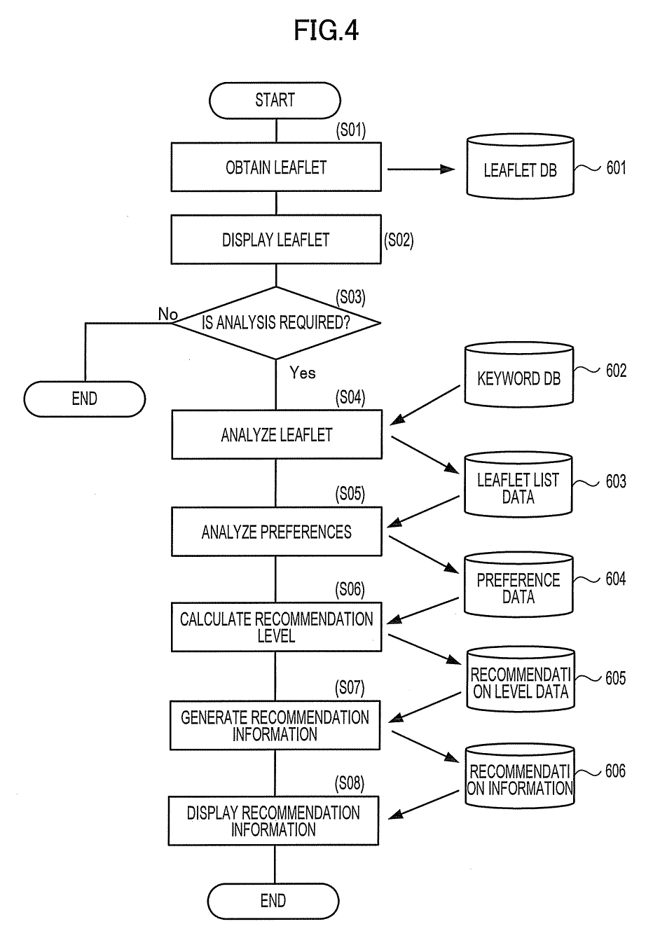

FIG. 4 is a flowchart illustrating a series of processes performed within the PC 100.

Here, first, the leaflet on the image data is obtained by the leaflet obtaining section 501 (operation S01), and the leaflet is displayed (operation S02), or the obtained leaflet is stored in a leaflet DB 601.

FIG. 5 illustrates an example of the leaflet.

This FIG. 5 illustrates the store name, the genres, the commodity names, the prices, the sale period and the like.

If the user is not interested in this leaflet, this leaflet is discarded, and if the user is interested in this leaflet, an analysis instruction is issued by using the keyboard 140 or the mouse 150 (operation S03).

If the user issues the analysis instruction, the analysis is performed by the leaflet analysis section 502 (operation S04), and leaflet list data 603 is updated.

It should be noted that the processes in operation S02 and operation S03 in the flowchart illustrated in FIG. 4 may be skipped. In that case, after the process in operation S01, the process proceeds to operation S04, and the analysis of the leaflet obtained in operation S01 is automatically performed without receiving the analysis instruction from the user.

In this example, various keywords have been registered in a keyword DB 602. These keywords include, for example, “STORE”, “shop” and the like representing a portion of the store name, “PERSONAL COMPUTER”, “TELEVISION SET” and the like representing a portion of the genre or the commodity name, numbers, characters of “YEN”, a sign “\” and the like representing the price, and MM/DD, month MM and DD, and the like representing a deadline or a period.

The leaflet analysis section 502 extracts the same characters or the like as characters or the like registered in the keyword DB 602, from the leaflet which is the analysis target this time, by the character recognition, and updates the leaflet list data. In this extraction, as surrounded by dashed boxes in FIG. 5, the commodity name and the price which are close to each other on the leaflet are extracted as a set (for example, “personal computer A” and “200 thousand yen”, or the like), or the commodity name and the price are extracted as the set by using boxes or the like separating respective commodities on the leaflet.

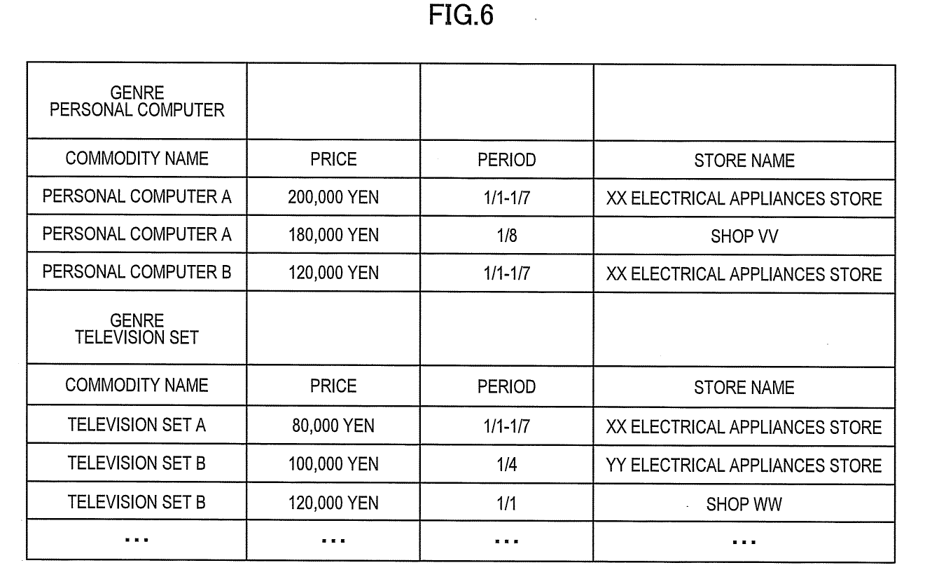

FIG. 6 illustrates an example of the leaflet list data.

This FIG. 6 has been generated as a result of analyzing a plurality of the leaflets by the leaflet analysis section 502. In this leaflet list data, the commodity name, the price, the period, the store name and the like have been stored, and information has been classified by the genre (“personal computer” and “television set”).

Next, preference analysis is performed by the preference analysis section 503, and preference data 604 is generated from the leaflet list data 603 (operation S05).

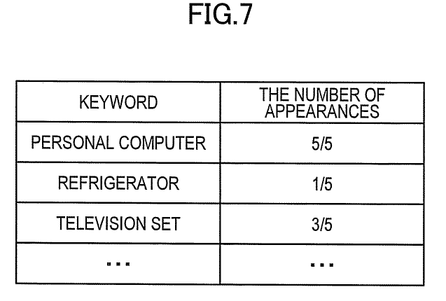

FIG. 7 illustrates an example of the preference data.

The preference analysis section 503 extracts the preference data of FIG. 7, in which the keyword which has appeared in the leaflet list data and the number of appearances thereof have been recorded. In this FIG. 7, for example, “the number of appearances” of 3/5 associated with the keyword “television set” means that there have been three leaflets in which the keyword “television set” has been inserted, among five leaflets which have been analyzed.

In this way, the preference data generated based on the leaflet list data illustrated in FIG. 6 or leaflet analysis data is cumulatively updated each time a new leaflet is analyzed.

It should be noted that although similar items as the genres in the leaflet list data illustrated in FIG. 6 are arranged in a field for the keyword in the preference data illustrated in FIG. 7, the keyword is not limited to the same string as the genre. For example, this keyword may include the commodity name, the store name, a manufacturer name and the like in addition to the genre, and the number of appearances of each of those keywords may be recorded in the preference data. However, in the generation of the preference data, instead of setting all the keywords as targets, the keywords such as “yen” and “day”, which are naturally described in the leaflet, may not be set as the targets.

Next, the recommendation information is generated by the recommendation information generation section 504. In the generation of this recommendation information, in the present embodiment, first, the recommendation level is calculated and recommendation level data 605 is generated based on the preference data 604 (operation S06), and next, recommendation information 606 is generated based on the recommendation level data 605 (operation S07).

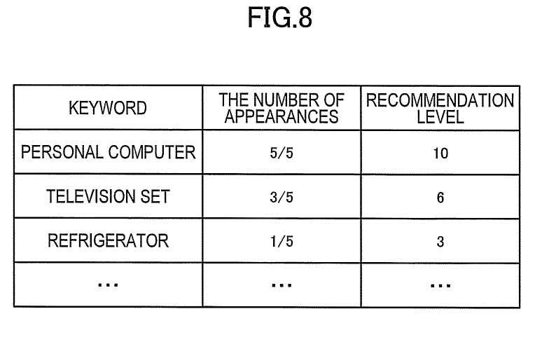

FIG. 8 illustrates an example of the recommendation level data.

In this example, the recommendation level of each keyword is calculated by using the number of appearances of each keyword in the leaflet analysis data (this number of appearances has been edited as the preference data as illustrated in FIG. 7) as a basis. If this recommendation level has been based only on the number of appearances, the preference data directly becomes the recommendation level data. In this example, the recommendation level is not only calculated based on the number of appearances, but is also calculated by weighting the number of appearances, for example, by other elements such as whether an on-sale period is new or old, whether the sale period is long or short, sex and age of the user, and the like.

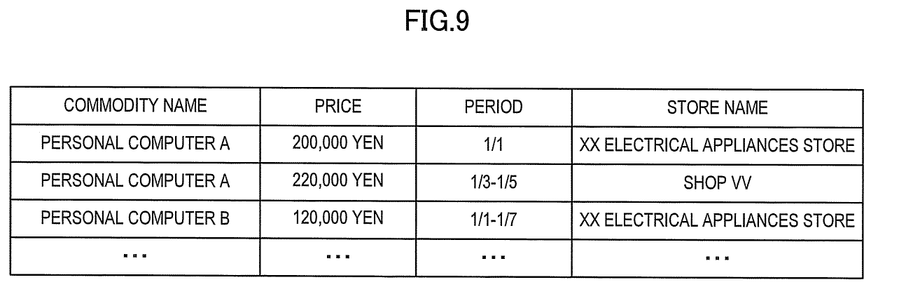

FIG. 9 illustrates an example of the recommendation information.

In the generation of this recommendation information, the keyword in which the user is interested (in this example, “personal computer” with the largest number of appearances) is specified based on the calculated recommendation level. The recommendation information as illustrated in FIG. 9 is generated with reference to the leaflet list data by using the specified keyword.

The recommendation information providing section 505 displays the generated recommendation information 606 on the display screen of the PC 100 (operation S08).

With reference to the recommendation information displayed on the display screen, the user can easily reach the leaflet in which the user is interested, by displaying the leaflet itself which has been stored in the leaflet DB 601 and inserted in the recommendation information, or the like.

It should be noted that, in this example, although the recommendation information includes only one keyword (“personal computer”), keywords of which a frequency of appearance is at a level higher than or equal to a predetermined upper level, among a plurality of the keywords, may be used, and the recommendation information including those keywords may be generated and displayed.

The leaflet analysis data may be limited in the period, for example, may be limited to data analyzed within the last one month, or the like. Moreover, in the leaflet analysis data, if the sale period inserted in each leaflet has expired, the information on the leaflet may be deleted. The same applies to various data and the like generated or edited based on the leaflet analysis data.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An information providing apparatus, comprising:
a leaflet obtaining section that obtains at least one leaflet containing data;
a leaflet analysis section that extracts information on the at least one leaflet obtained by the leaflet obtaining section and updates leaflet list data, the leaflet list data being a list of the information extracted from a plurality of the leaflets;
a preference analysis section that calculates a number of appearances of information of a same keyword in the leaflet list data and generates preference data in which a correspondence between the keyword and the number of appearances thereof has been recorded;
a recommendation information generation section that selects a keyword based on the number of appearances in the preference data, extracts information including the selected keyword from the leaflet list data, and generates recommendation information based on the extracted information; and
a recommendation information providing section that provides the recommendation information to a user.

2. The information providing apparatus according to claim 1, further comprising a scanner for scanning a printed leaflet,
wherein the leaflet obtaining section obtains the at least one leaflet by using the scanner.

3. The information providing apparatus according to claim 1, wherein
the information providing apparatus is connected to a network, and
the leaflet obtaining section obtains the at least one leaflet through the network.

4. The information providing apparatus according to claim 1, wherein
the at least one leaflet is a leaflet containing image data, and
the leaflet analysis section extracts information that has appeared on the at least one leaflet by character recognition.

5. The information providing apparatus according to claim 1, wherein
the leaflet analysis section extracts at least a commodity name, a price, a sale day or period, and a store name from the at least one leaflet.

6. The information providing apparatus according to claim 1, wherein
the recommendation information generation section calculates a recommendation level for each keyword by using the number of appearances in the preference data as at least one basis, and selects the keyword based on the recommendation level.

7. A computer-readable storage medium storing a program executed in a computer, the program causing the computer to function as:
a leaflet obtaining section that obtains at least one leaflet containing data;
a leaflet analysis section that extracts information on the at least one leaflet obtained by the leaflet obtaining section and updates leaflet list data, the leaflet list data being a list of the information extracted from a plurality of the leaflets;
a preference analysis section that calculates a number of appearances of information of a same keyword in the leaflet list data and generates preference data in which a correspondence between the keyword and the number of appearances thereof has been recorded;
a recommendation information generation section that selects a keyword based on the number of appearances in the preference data, extracts information including the selected keyword from the leaflet list data, and generates recommendation information based on the extracted information; and
a recommendation information providing section that provides the recommendation information to a user.

8. The computer-readable storage medium according to claim 7, wherein
the computer comprises a scanner for scanning a printed leaflet, and
the leaflet obtaining section obtains the at least one leaflet by using the scanner.

9. The computer-readable storage medium according to claim 7, wherein
the computer is connected to a network, and
the leaflet obtaining section obtains the at least one leaflet through the network.

10. The computer-readable storage medium according to claim 7, wherein
the at least one leaflet is a leaflet containing image data, and
the leaflet analysis section extracts information that has appeared on the at least one leaflet by character recognition.

11. The computer-readable storage medium according to claim 7, wherein
the leaflet analysis section extracts at least a commodity name, a price, a sale day or period, and a store name from the at least one leaflet.

12. The computer-readable storage medium according to claim 7, wherein
the recommendation information generation section calculates a recommendation level for each keyword by using the number of appearances in the preference data as at least one basis, and selects a keyword based on the recommendation level.

13. An information providing method executed in a computer, the method comprising:
obtaining at least one leaflet containing data;
extracting information that appears on the obtained at least one leaflet;
generating leaflet list data that is a list of the information extracted from a plurality of the leaflets;
calculating a number of appearances of information of a same keyword in the leaflet list data;
generating preference data in which a correspondence between the keyword and the number of appearances thereof has been recorded;
selecting a keyword based on the number of appearances in the preference data;
extracting information including the selected keyword from the leaflet list data;
generating recommendation information by using the extracted information; and
providing the recommendation information to a user.

14. The information providing method according to claim 13, wherein
the obtaining obtains the at least one leaflet by using the scanner.

15. The information providing method according to claim 13, wherein
the obtaining obtains the at least one leaflet through a network.

16. The information providing method according to claim 13, wherein
the extracting extracts information which has appeared on the at least one leaflet by character recognition.

17. The information providing method according to claim 13, wherein
the extracting extracts at least a commodity name, a price, a sale day or period, and a store name from the at least one leaflet.

18. The information providing method according to claim 13, wherein
the selecting calculates a recommendation level for each keyword by using the number of appearances in the preference data as at least one basis, and selects the keyword based on the recommendation level.
